(19) United States
(12) Patent Application Publication
(10) Pub. No.: US 2026/0167580 A1
(43) Pub. Date: Jun. 18, 2026

(54) Methods of Altering Radiative Forcing by Modifying Surface Albedo and Removing Carbon Dioxide

(71) Applicant: Brown University, Providence, RI (US)

(72) Inventors: John Bradley Marston, Providence, RI (US); Daniel Ibarra, Pawtucket, RI (US)

(21) Appl. No.: 19/419,731

(22) Filed: Dec. 15, 2025

Related U.S. Application Data
(60) Provisional application No. 63/734,212, filed on Dec. 16, 2024.

(51) Int. Cl. C05D 3/02; A01C 21/00; B01D 53/62; B01D 53/82; C05D 3/00

(52) U.S. Cl. CPC C05D 3/02; A01C 21/00; B01D 53/62; B01D 53/82; C05D 3/00; B01D 2251/404; B01D 2257/504; B01D 2258/06

(57) ABSTRACT

A method of increasing soil albedo to reduce radiative forcing while also removing atmospheric CO₂ is provided, which may also include improving soil pH and soil nutrients.

### CROSS-REFERENCE TO RELATED APPLICATION

The present application claims priority benefit of U.S. Provisional Application No. 63/734,212, filed Dec. 16, 2024, which is herein incorporated by reference in its entirety.

### FIELD

The present invention relates in general to a method of climate intervention that combines surface albedo modification using crushed rock or mineral soil amendments with atmospheric carbon dioxide removal through enhanced rock weathering. Certain crushed rock or mineral soil amendments may improve soil pH and may increase soil nutrients.

### BACKGROUND

Most solar radiation management schemes (SRM) to cool Earth have focused on reflecting sunlight by stratospheric aerosol injection or by brightening marine clouds. More speculatively, the thinning of cirrus clouds to enhance long-wave emission has also been considered. These schemes are controversial. Surface albedo modification is known. See Weber et al., Chemistry-albedo feedbacks offset up to a third of forestation's CO₂ removal benefits. Science, 383 (6685):860-864, 2024. ISSN 0036-8075. doi: 10.1126/science.adg6196; Hamwey, Mitigation and Adaptation Strategies for Global Change (2007) 12:419-439; and Kristensen et al., Tree planting is no climate solution at northern high latitudes. Nature Geoscience, 17(11):1087-1092, 2024. ISSN 1752-0894. doi: 10.1038/s41561-024-01573-4.

Enhanced Rock Weathering (ERW) seeks to capture atmospheric CO₂ using rocks and/or minerals that are out of equilibrium at Earth's surface to generate alkalinity via surficial weathering reactions. However, methods are needed that combine enhanced rock weathering and solar radiation management to achieve CO₂ removal and cooling of the Earth's temperature.

### SUMMARY

Aspects of the present disclosure are directed to a method of addressing climate change by cooling the Earth by increasing surface reflectance through the distribution over large land surfaces of one or more types of materials such as rocks and/or minerals and/or combinations or mixtures thereof that increase surface reflectance and that also remove carbon dioxide from the environment over time. It is understood that materials may be naturally occurring materials such as rocks and/or minerals or synthetic materials that have the capability to increase surface albedo, remove carbon dioxide or both. According to one aspect, certain exemplary rocks and/or minerals distributed over large surface areas may contribute to both an increase of surface reflectance and removal of environmental CO₂ in the atmosphere and soil. Radiative forcing, ΔF, is the change in the downward minus upward radiative flux. It is the base driver of climate change. As is known in the art, a decrease in radiative forcing contributes to a cooling effect. An increase in radiative forcing contributes to a heating effect.

Aspects of the present disclosure are directed to the use of enhanced rock weathering (ERW) to remove carbon dioxide from the atmosphere and/or soil, referred to herein as carbon dioxide removal or “CDR”. As is known in the art, enhanced weathering (EW) is a CO₂ removal (CDR) and sequestration strategy that accelerates the natural reactions of minerals that can export carbon from the atmosphere and soil resulting from biotic reactions to oceanic sinks. One method of EW as described herein is to apply finely ground silicate rocks, or other minerals of high surface area, or other rocks and minerals as described herein that react with carbon dioxide, to large tracts of land, such as agricultural lands. According to one aspect, substantial amounts of carbon dioxide are removed from the atmosphere by applying enhanced rock weathering (ERW) to very large land areas, such as on a scale for ameliorating climate change. According to one aspect, modifying large surface areas of the Earth also results in significant changes in radiative forcing due to changes in albedo (reflectance). According to the present disclosure, surface albedo modification (SAM) can exceed the reduction in radiative forcing from the decrease of atmospheric CO₂ due to ERW over timescales of decades. According to the present disclosure, methods are provided that determine radiative impacts of ERW with large scale ERW deployments. According to the present disclosure, methods are provided that determine radiative impacts of surface albedo modification resulting from large scale deployments of rocks and/or minerals useful in ERW. SAM via ERW applications can be either positive or negative depending on the choice of rock and/or mineral. Depending on the albedo of the untreated soil, mafic or ultramafic rocks and/or minerals deposited over large tracts of land may decrease soil albedo (reflectance) and thus contribute to warming. Conversely, materials such as whitish minerals such as wollastonite have high albedo and when deposited over large tracts of land can increase the reflectance of sunlight and cool the Earth.

Aspects of the present disclosure are based on the recognition that the radiative forcing from application of ground mafic or ultramafic rock to soil which may be used to remove CO₂ from the atmosphere or soil may affect the soil reflectance in a manner to reduce reflectance (albedo) and that the resulting radiative forcing can be larger than that due to the removed carbon dioxide. Aspects of the present disclosure are directed to measuring albedo changes due to soil amendments with rocks and/or minerals of high surface area, such as crushed silicate rock, that can remove CO₂ from the environment. According to one aspect, the radiative forcing of certain ground rock and/or minerals as described herein applied to soil has a larger climate intervention effect than the intended CDR, and therefore provides greater effective climate intervention.

According to one aspect, certain rocks and/or minerals can be selected for enhanced weathering to remove CO₂ and also to increase the albedo of the amended soil thus combining three benefits: solar radiation management by increasing albedo to result in climate cooling, carbon dioxide removal to result in climate cooling, and soil amendment to improve growth conditions for crops. Exemplary rocks and/or minerals alone or as combinations for comminution (grinding) and spreading are selected on the basis of (1) radiative impact (increased albedo), (2) rate of weathering that would increase alkalinity in soil for CDR, and (3) co-benefits for agricultural crops, where large areas of land would be utilized.

Further features and advantages of certain embodiments of the present invention will become more fully apparent in the following description of embodiments and drawings thereof, and from the claims.

### BRIEF DESCRIPTION OF THE DRAWINGS

The foregoing and other features and advantages of the present embodiments will be more fully understood from the following detailed description of illustrative embodiments taken in conjunction with the accompanying drawings in which:

FIG. 1 is a graph of the time evolution of the reduced global radiative forcing from treatment of one hectare of land.

FIG. 2 shows global mean radiative forcing after 1 year from ERW and SAM on 10⁶ km² of land versus albedo change for three application rates assuming a 5% efficiency.

### DETAILED DESCRIPTION

The present disclosure provides methods of providing a material including one or more types of rocks and/or minerals and/or combinations or mixtures thereof to large surface areas of land to facilitate enhanced rock weathering and CO₂ capture while also modifying surface albedo, the combination of which facilitates cooling of the environment.

There are multiple potential benefits to the combination of ERW with (cooling) SAM: (1) Immediate cooling by increased surface reflectance (albedo) would be followed by (2) the slow removal of atmospheric CO₂, thereby addressing the root cause of climate change. Furthermore, ERW offers co-benefits to agriculture via soil amendments, for example from crushed rock and/or mineral potentially making deployment over large areas attractive to farmers. Finally, certain rocks and/or minerals providing ERW can be deployed on a large scale to also facilitate solar radiation management (SRM). Aspects of the present disclosure are directed to the radiative impact of rocks and/or minerals selected for ERW and CO₂ capture and determining the surface albedo modification (SAM) resulting from rocks and/or minerals selected for enhanced rock weathering and CO₂ capture. Aspects of the present disclosure are directed to the systematic measurement of SAM due to ERW. According to one aspect, radiative forcing due to SAM occurs when certain rocks and/or minerals or combinations or mixtures thereof are applied to large surface areas to increase reflectance and therefore promote atmospheric cooling. Such radiative forcing is intended to exceed that of ERW and to promote cooling sooner than that achieved by ERW. According to one aspect, methods are provided for optimizing ERW and SAM on a large scale by applying selected rocks and/or minerals or combinations or mixtures thereof to large land areas to maximize global cooling both in the short and long term.

### Enhanced Rock Weathering (ERW)

As is known in the art, ERW seeks to capture atmospheric CO₂ using certain materials that are out of equilibrium at Earth's surface to generate alkalinity via surficial weathering reactions. See Thomas Rinder and Christoph von Hagke, The influence of particle size on the potential of enhanced basalt weathering for carbon dioxide removal—insights from a regional assessment. Journal of Cleaner Production, 315:128178, September 2021. ISSN 0959-6526. doi: 10.1016/j.jclepro.2021.128178. URL dx.doi.org/10.1016/j.jclepro.2021.128178; Beerling et al., Potential for large-scale CO2 removal via enhanced rock weathering with croplands. Nature, 583(7815):242-248, 2020; and Beerling et al., Enhanced weathering in the US Corn Belt delivers carbon removal with agronomic benefits. Proceedings of the National Academy of Sciences, 121(9):e2319436121, 2024. ISSN 0027-8424. doi: 10.1073/pnas.2319436121.

According to the present disclosure, methods are provided for mining, crushing, and grinding rock containing reactive minerals and spreading them over large areas in agricultural or managed land settings with the possibility of repeat applications on a designated (likely seasonal) timescale. There, the rock and/or mineral dust reacts with atmospheric and soil CO₂, the latter of which is derived from root and microbial respiration, to form relatively stable carbonates or (in most cases) carbonate species, in the form of bicarbonate in most settings, in solution that is delivered to the ocean via rivers and thus enhances ocean alkalinity. Such soil amendments may, in certain settings, also enhance soil organic carbon stocks. According to the present method, ERW facilitates and increases natural weathering processes by overcoming the kinetic and physical limitations via enhanced surface area in finely ground rock and/or mineral applied to the top of soils in order to capture significant quantities of atmospheric CO₂ over human time scales. See for example Campbell et al., Geochemical Negative Emissions Technologies: Part I. Review. Frontiers in Climate, 4: 879133, 2022; Breunig et al., Economical deployment of quarry minerals for land-based enhanced weathering in Northern California. 2024. doi: 10.26434/chemrxiv-2024-n3lkf-v2; and Goll et al., Potential CO2 removal from enhanced weathering by ecosystem responses to powdered rock. Nature Geoscience, 14(8):545-549, 2021. ERW attempts to speed up these natural weathering processes by overcoming the kinetic and physical limitations via enhanced surface area in finely ground rock applied to the top of soils in order to capture significant quantities of atmospheric CO₂ over years to decades.

According to certain aspects, specific rocks and/or minerals are selected for enhanced surficial weathering. Such rocks and/or minerals can be identified by those of skill in the art based on the present disclosure. For example, dark mafic and ultramafic rocks such as basalt or peridotite decrease soil albedo whereas whitish minerals such as wollastonite increase the reflectance. Wollastonite reacts with carbon dioxide exothermically as summarized by the following reaction:

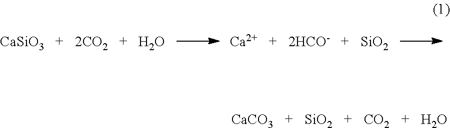

Based on Equation 1, the theoretical removal efficiency of wollastonite to sequester CO₂ is 0.76 kg CO₂ per kg of wollastonite applied. In actual experiments the rate of CO₂ sequestration has been shown to vary between 87 and 255 kg CO₂ per ton of wollastonite for each year of soil amendments. See Haque et al., Optimizing inorganic carbon sequestration and crop yield with wollastonite soil amendment in a microplot study, Frontiers in plant science, 11:1012, 2020; and Wood et al., Impacts of dissolved phosphorus and soil-mineral-fluid interactions on CO₂ removal through enhanced weathering of wollastonite in soils. Applied Geo-chemistry, 148:105511, 2023.

Materials useful in enhanced rock weathering to remove CO₂ from the atmosphere and soil are those that include one or more rocks and/or minerals that directly or indirectly react with the CO₂ to form a carbonate. According to one aspect, the rock and/or mineral reacts directly with CO₂ under appropriate reaction conditions, such as temperature and moisture conditions found naturally in the environment. According to one aspect, the rock and/or mineral reacts indirectly with CO₂, such as where CO₂ reacts under temperature and moisture conditions found naturally in the environment to form carbonic acid or carbonate, for example, and the rock and/or mineral reacts with the carbonic acid or carbonate, to form carbonate or bicarbonate. Accordingly, aspects of the present disclosure are directed to materials useful in enhanced rock weathering to remove CO₂ from the atmosphere and soil. Exemplary materials may be natural or synthetic and may include minerals.

Exemplary minerals may be present in rock. Exemplary minerals may be synthesized. Exemplary minerals may be commercially available. Exemplary rocks and/or minerals useful for enhanced rock weathering methods as described herein include one or more of basalt, olivine, ultramafic rock, quartz, wollastonite, calcite (calcium carbonate), magnesite (magnesium carbonate), brucite, calcium hydroxide (portlandite), calcium oxide, lime (calcium oxide and hydroxide mixtures), limestone (such as commercially available limestone pellets) and the like or combinations or mixtures thereof. Exemplary materials such as rocks and/or minerals as described herein may also have an average particle size in the range of 1 micron to 5 millimeters, such as 10 microns to 5 millimeters, such as 100 microns to 5 millimeters, such as 1 millimeter to 5 millimeters and the like. It is to be understood that the particle size is related to surface area and that the higher the surface area, the greater the likelihood of reaction directly or indirectly with CO₂ in the environment. Is it to be understood that the amount of materials such as rocks and/or minerals as described herein added to soil or otherwise placed on soil for enhanced rock weathering can vary. According to one aspect, the amount of materials such as rocks and/or minerals added to soils can range from between 1 and 100 tonnes per hectare, such as 10 to 100 tonnes per hectare, such as 50 to 100 tonnes per hectare and the like.

### Surface Albedo Modification (SAM)

As is known in the art, surface albedo modification (SAM) is a solar radiation management (SRM) climate intervention strategy that aims to increase the Earth's reflectivity to reduce the amount of solar radiation absorbed by the Earth's surface. Surface albedo can be enhanced by altering types of grasses or man-made structures. See Hamwey, Mitigation and Adaptation Strategies for Global Change (2007) 12:419-439. Surface albedo modification aims to reflect more sunlight back to space by enhancing Earth albedo—the sunlight reflected off the Earth's surface. Albedo describes how much solar radiation is reflected by a surface. A high albedo means most solar radiation is reflected, for example polar ice sheets. A surface with a low albedo, for example a dark ocean surface, reflects only a relatively small share and absorbs most of the solar radiation in the form of heat, thus contributing to warming the surrounding area.

Aspects of the present disclosure is directed to selecting materials, such as those including rocks and/or minerals, that increase surface albedo. Such rocks and/or minerals can be identified by those of skill in the art based on the present disclosure. Rocks can be the source of such minerals which are ground and/or crushed to a desired average particle size or dust and then spread over large surface areas and optionally worked into the soil while retaining an amount of the mineral at the surface for reflectance of light. Such materials may be deposited on the surface of land without working into the soil. Such materials include rocks and/or minerals which tend to reflect light compared to rocks and/or minerals which tend to absorb light. Such rocks and/or minerals include whiteish rocks/and or minerals which reflect light, such as calcium containing rocks and/or minerals and exclude darkish rocks and/or minerals which absorb light, such as magnesium and iron containing rocks and/or minerals. The general principle for selecting whitish rocks and/or minerals for combined ERW with SAM is to avoid mafic or ultramafic rocks and/or minerals, that is, ones that contain magnesium (Mg) and iron (Fe) which may be useful for ERW but are generally considered not useful for SAM. However, it is to be understood that aspects of the present disclosure are directed to combinations of materials which are useful for ERW and materials with are useful for SAM. A selected material need not be useful for both ERW and SAM, however, such a material would be considered a preferred material Calcium is a good alternative to magnesium as a divalent cation, hence wollastonite is exemplary but also CaO and slaked lime (calcium hydroxide) and calcium carbonate are exemplary. Further exemplary minerals include pure magnesium minerals like brucite Mg(OH)₂ with no iron. According to one aspect, exemplary materials including rocks and/or minerals include wollastonite, calcite (calcium carbonate), magnesite (magnesium carbonate), brucite, calcium hydroxide, calcium oxide, limestone (such as commercially available limestone pellets) and the like or combinations or mixtures thereof. Exemplary materials such as rocks and/or minerals as described herein may have an average particle size in the range of 1 micron to 5 millimeters, such as 10 microns to 5 millimeters, such as 100 microns to 5 millimeters, such as 1 millimeter to 5 millimeters and the like. Is it to be understood that the amount of materials such as rocks and/or minerals as described herein added to soil or otherwise placed on soil for surface albedo modification can vary. According to one aspect, the amount of materials such as rocks and/or minerals added to soils can range from between 1 and 100 tonnes per hectare, such as 10 to 100 tonnes per hectare, such as 50 to 100 tonnes per hectare and the like. Accordingly, aspects of the present disclosure are directed to materials useful for SAM to increase surface albedo. Exemplary materials may be natural or synthetic and may include rocks and/or minerals.

### Combined ERW and SAM

According to one aspect, large surface areas are modified in surface albedo to have a significant impact on the global climate. According to one aspect, land areas are treated with a material useful in enhanced rock weathering to remove CO₂ from the environment. According to one aspect, land areas are treated with a material useful in increasing surface albedo modification. According to one aspect, land areas are treated with a material useful in enhanced rock weathering to remove CO₂ from the environment and a material useful in increasing surface albedo modification. According to one aspect, land areas are treated with a material that is useful in enhanced rock weathering to remove CO₂ from the environment and is also useful in increasing surface albedo modification. According to one aspect, exemplary rocks and/or minerals that are useful in enhanced rock weathering to remove CO₂ from the environment and are also useful in increasing surface albedo modification include wollastonite, calcite (calcium carbonate), magnesite (magnesium carbonate), brucite, calcium hydroxide, calcium oxide, limestone (such as commercially available limestone pellets) and the like or combinations or mixtures thereof. Exemplary materials such as rocks and/or minerals as described herein may have an average particle size in the range of 1 micron to 5 millimeters, such as 10 microns to 5 millimeters, such as 100 microns to 5 millimeters, such as 1 millimeter to 5 millimeters and the like. Is it to be understood that the amount of materials such as rocks and/or minerals as described herein added to soil or otherwise placed on soil for enhanced rock weathering and surface albedo modification can vary. According to one aspect, the amount of materials such as rocks and/or minerals added to soils can range from between 1 and 100 tonnes per hectare, such as 10 to 100 tonnes per hectare, such as 50 to 100 tonnes per hectare and the like.

According to one aspect, large surface areas are modified with selected materials such as rocks and/or minerals to provide ERW and also have significant SAM effects. The present disclosure modifies large surface areas of Earth to provide enhanced rock weathering and CO₂ removal and also significant surface albedo modification resulting in significant reflected light. As large areas are required for ERW on a gigaton scale, the present disclosure provides for selection of materials such as rocks and/or minerals that provide cooling SAM in conjunction with ERW. As a point of reference, if the albedo of the 4.8 gigahectares of land used worldwide for agriculture were increased by 0.1, that would result in Earth cooling by approximately 5° C. According to the present disclosure, methods are provided for reducing the average temperature of the Earth by large scale increasing of surface albedo. For example, even if only 20% of agriculture land were brightened by increasing the albedo by 0.1, that would lead to a considerable cooling of global mean temperature by about 1 degree C. According to the present disclosure, the land area to be treated as described herein has an area between 0.1 and 100,000 hectares, such as 10 to 100,000 hectares, such as 10 to 10,000 hectares, such as 100 to 10,000 hectares and the like.

Radiative forcing (RF) is a measure of the difference between the amount of energy that enters a planet and the amount that leaves it. The change in radiative forcing due to reflection from crushed rock or mineral soil amendments far exceeds that due to CO₂ uptake for years after application. For example, consider ERW at a rate of 10 T CO₂/ha/year, and for the purpose of illustration consider the land area required to remove 1 GT CO₂/year, namely 10⁶ km². This large amount of land that is required for ERW has the consequence that slight changes in albedo cause significant radiative forcing. However, the relative importance of SAM versus ERW does not depend on the size of the treated area.

Radiative forcing due to ERW is spread out over the globe because CO₂ is a well-mixed gas, whereas the intense forcing due to SAM is localized over areas of land treated with rock and/or minerals. Atmospheric circulation can also mix this forcing over the globe.

Accordingly, aspects of the present disclosure combine surface treatment that increases surface albedo and also increases CO₂ removal from the environment. The combined effect of increasing surface albedo and increasing CO₂ removal from the environment promotes a lowering of surface air temperature.

### Surface Treatment Methods

Aspects of the present disclosure contemplate treating land, such as farmland, with a material as described herein that is capable of participating in the removal of environmental CO₂ and/or is capable of increasing the albedo of the land relative to the land without the material. According to one aspect, the material is uniformly spread over the surface of the land. According to one aspect, the material is spread over the surface of the land in an amount of 1 to 100 tonnes per hectare. According to one aspect, the material is deposited over the surface of the land without tilling the material into the soil. It is to be understood that some amount of mixing into the soil can occur during the process of depositing the material onto the surface of the soil, but no affirmative tilling is carried out to mix the material into the soil. According to one aspect, the material is mixed with the soil using conventional tilling methods such that the material is mixed to an average depth of about 1 to 10 inches or 2 to 20 centimeters or 5 to 20 centimeters. A typical tilling depth is 15 centimeters. According to one aspect, material may be deposited over the surface of the land without tilling the material into the soil and maintaining the material on the surface of the soil for one growing season or one year and then tilling the material into the soil after one growing season or one year According to one aspect, material resides at the surface of the soil so that it can contribute to reflection of sunlight, thereby increasing albedo. According to one aspect, representative surface amounts includes 100% coverage of the surface by the material to 1% coverage of the surface by the material, such as 75% to 1%, such as 75% to 20%, such as 50% to 1%, such as 50% to 20%, such as at most 50% and the like.

According to one aspect, surface treatment of the soil as described herein results in an increase of surface albedo from 0.01 to 0.20 as measured as described herein, with an increase of surface albedo from 0.01 to 0.10 being exemplary.

### Surface Albedo Measurement

According to certain aspects, a method of determining surface albedo is provided herein. A portable “class A” (highest accuracy with a flat spectral response) albedometer that consists of a pair of pyranometers is used, with one pyranometer directed to the ground below and another pyranometer aimed at the sky above, to measure the ratio of the outgoing to incoming visible radiation. Suitable instruments are made by Kipp & Zonen (an OTT HydroMet brand) and EKO Instruments Co., Ltd. The pair of pyranometers are attached to a rod that extends horizontally outward from a supporting tripod at a height of 1 to 3 meters above the surface to be measured. A digital data logger records the downward and upward irradiance at regular intervals. Standard protocols that have been developed for albedo measurements are used. See Sailor et al., Field measurement of albedo for limited extent test surfaces, Solar Energy, 80(5):589-599, 2006; Tirel et al., Field and laboratory characterization of the albedo of asphalt and horizontal surfaces, Materials and Structures 58:262 (2025) https://link.springer.com/article/10.1617/s11527-025-02787-7; and Adams et al., A model-based framework for the quality assessment of surface albedo in situ measurement protocols, Journal of Quantitative Spectroscopy and Radiative Transfer, 180:126-146, 2016.

### Example I

Changes in Radiative Forcing from Albedo Modification and CO₂ Removal

An assumed treated area of ΔA=10⁶ km² is a fraction ΔA/A=0.2% of Earth's total surface area of A=5.1×10⁸ km². The average solar irradiance G is ¼ of the solar constant (ignoring for simplicity latitude and atmospheric effects). At the top of the atmosphere therefore G=340 W/m².

Ignoring for the sake of simplicity latitude and scattering of light by the atmosphere and clouds (which reduces this number to an average of 185 W/m²), a change in albedo Δa alters the radiative forcing ΔF_{SAM}, averaged over the Earth's surface, by

$$Δ {F}_{SAM} = - Δ a G \frac{Δ A}{A} = - ( 0.7 W / {m}^{2} ) \times Δ a . \qquad ( 2 )$$

This value can be compared to the radiative forcing ΔF_{CDR} due to the removal of ΔC=−1 GT of CO2. Assuming about C=3,500 GT CO₂ in the atmosphere, and upon making a linear approximation to the actual logarithmic dependence on CO₂ concentration, the change in the radiative forcing due to the reduction in atmospheric CO₂ by 1 GT is approximately

$$Δ {F}_{CDR} = ( 5.35 W / {m}^{2} ) \times \frac{Δ C}{C} = - 1.5 \times {10}^{- 3} W / {m}^{3} . \qquad ( 3 )$$

Thus, comparing Equation 2 to Equation 3, it is evident that even a tiny brightening of the albedo from, for example, 0.300 to 0.302, or Δa=2×10⁻³, would change the SAM radiative forcing by an amount comparable to that due to the CO₂ removed by ERW in one year. A simple model for the removed CO₂ is ΔC=−k t ΔA where t is time and k is a reaction rate, e.g. k=10 T/ha/year.

A change in albedo Δa therefore alters the radiative forcing, averaged over the Earth's surface, by about −0.7 Δa (W/m²). As above, this value can be compared to the radiative forcing due to the removal of 1 GT of CO₂. Assuming about 3,500 GT CO₂ in the atmosphere, and upon making a linear approximation to the actual logarithmic dependence (see Myhre et al., New estimates of radiative forcing due to well mixed greenhouse gases, Geophysical Research Letters, 25(14):2715-2718, 1998; and Mlynczak et al., The spectroscopic foundation of radiative forcing of climate by carbon dioxide, Geophysical Research Letters, 43(10):5318-5325, 2016) of the radiative forcing on CO₂ concentration, the change in the radiative forcing due to the reduction in atmospheric CO₂ is approximately −5.35 W/m²*(1 GT/3500 GT).

According to one aspect, a brightening of the albedo from 0.300 to 0.303, or Δa=3×10⁻³, would change the radiative forcing by an amount comparable to that due to the CO₂ removed by ERW in one year. It is contemplated that albedo of the treated soils may change over time and it is also contemplated that repeat application of ground rock and or mineral may be required to maintain a desired albedo.

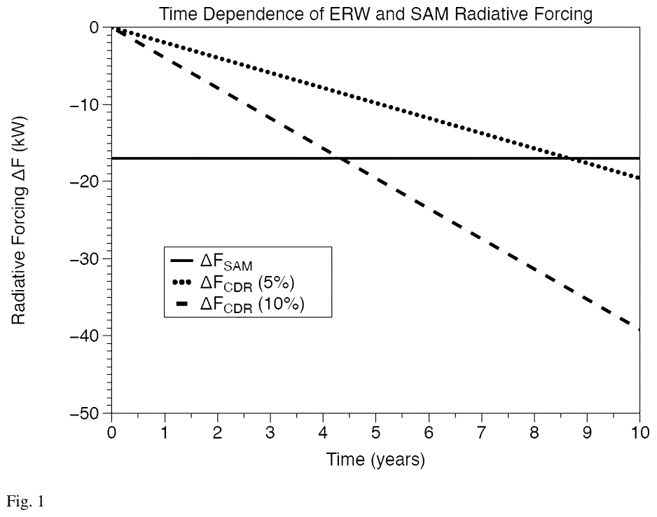

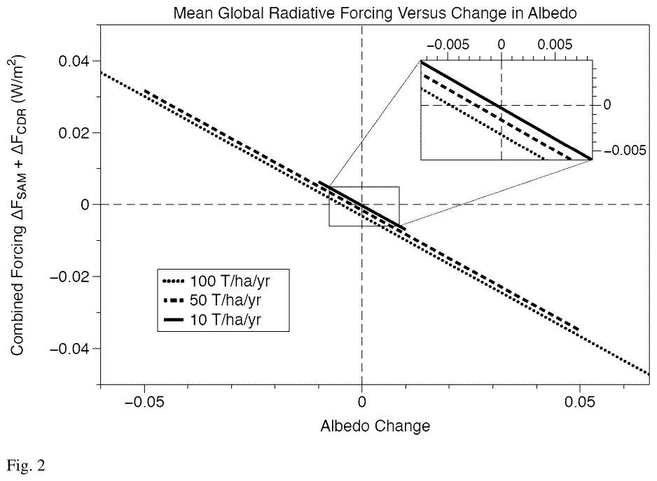

According to certain aspects, parameters of ERW and SAM may be adjusted. It is contemplated that typical increases in the albedo of order 0.01 to 0.10 lead to SAM radiative forcing that dominates over ERW for decades after treatment until sufficient CO₂ has been absorbed. FIG. 1 shows time evolution of the reduced global radiative forcing from treatment of one hectare of land. The enhanced rock weathering (ERW) assumes annual applications of 50 tons of crushed rock and/or mineral that absorb atmospheric CO₂ at an efficiency of either 5% or 10% of the rock and/or mineral mass. The mean annual surface albedo modification (SAM) is due to an assumed increase in albedo by 0.01 from the rock and/or mineral. Radiative forcing from ERW becomes similar to radiative forcing from SAM after multiple years. FIG. 2 shows global mean radiative forcing after 1 year from ERW and SAM on 10⁶ km² of land versus albedo change for three application rates assuming a 5% efficiency. As the albedo response to ERW depends on many factors, lines here represent possible values ranging from positive changes (cooling) to negative (warming).

### Example II

Modification of Large Surface Area of Earth to Affect Radiative Forcing from ERW and SAM

Measurements are carried out at an existing ERW farm site with large tracts of land for crops. The large tracts of farming soil are treated with crushed wollastonite provided by Canadian Wollastonite or commercially available limestone pellets.

A one-time 5 tons/acre (=12.35 T/ha) application of wollastonite dust or commercially available limestone pellets to a large tract of farming soil to be planted with a crop is made. Assuming that the wollastonite dust or commercially available limestone pellets is applied to the surface of the soil without tilling into the soil, the wollastonite dust or commercially available limestone pellets brightens the surface of the soil significantly. Albedo measurements are made initially and one year thereafter. Albedo measurements are made at least 4 times over the annual course including peak growing season and after harvest. Untreated tracts of farming soil serve as control permit ascertaining the impact of the wollastonite on albedo. Control and treatment plots to be provided with ERW applications are each 40 ha in area. Both the control and treatment plots are planted with corn. Measurements of CH₄ and N₂O emission reductions from wollastonite or limestone amendments are carried out using flux towers. Flux towers are erected in each plot. Albedo is determined as measured by a portable “class A” albedometer measuring the ratio of outgoing to incoming visible radiation. A portable “class A” (highest accuracy with a flat spectral response) albedometer that consists of a pair of pyranometers is used, with one pyranometer directed to the ground below and another pyranometer aimed at the sky above, to measure the ratio of the outgoing to incoming visible radiation. Suitable instruments are made by Kipp & Zonen (an OTT HydroMet brand) and EKO Instruments Co., Ltd. The pair of pyranometers are attached to a rod that extends horizontally outward from a supporting tripod at a height of 1 to 3 meters above the surface to be measured. A digital data logger records the downward and upward irradiance at regular intervals. Standard protocols that have been developed for albedo measurements are used. See Sailor et al., Field measurement of albedo for limited extent test surfaces, Solar Energy, 80(5):589-599, 2006; Tirel et al., Field and laboratory characterization of the albedo of asphalt and horizontal surfaces, Materials and Structures 58:262 (2025) https://link.springer.com/article/10.1617/s11527-025-02787-7; and Adams et al., A model-based framework for the quality assessment of surface albedo in situ measurement protocols, Journal of Quantitative Spectroscopy and Radiative Transfer, 180:126-146, 2016.

Crops grown on the large tracts alternate between soybeans and corn, so measurements are made from a fixed height greater than 1 to 3 meters to clear the crops. The change in albedo signal is resolvable with class A albedometers that have an absolute calibration uncertainty of less than 1.2%, and a much smaller relative uncertainty relevant for the comparison of control and treated plots. Multiple measurements are made in each plot to understand the statistical variations in albedo, and reduce uncertainty in the measurement of the mean albedo.

In addition to field measurements, representative soil samples and wollastonite or limestone are obtained for laboratory albedo testing. In a controlled laboratory setting and in full sunlight, a variety of soil to wollastonite or limestone mixtures is measured to quantify the change in albedo as a function of wollastonite or limestone addition, irrespective of vegetation change or other environmental factors.

According to one aspect, the present disclosure contemplates measuring change in albedo depending on variables such as the time of day (angle of the sun), time of year, soil moisture, depth of soil tilling if carried out, and crop cover.

According to one aspect, the present disclosure contemplates modeling the albedo as a weighted average of the separate soil and mineral albedos. Contemplated weighting factors include fractional mass density, fractional volume, and fractional area.

According to one aspect, the present disclosure contemplates tilling to mix the material dust uniformly in the soil or where a significant portion of the material dust remains on the top of the soil.

According to one aspect, the present disclosure contemplates the albedo evolving with repeated soil amendments or with extent of the crushed rock weathering.

Field measurements at regular temporal intervals quantify alkalinity changes due to soil amendments, and flux towers provide additional monitoring of greenhouse gas fluxes, including CO₂. See for example Knapp et al., Quantifying CO2 Removal at Enhanced Weathering Sites: a Multiproxy Approach, Environmental Science &; Technology, 57(26):9854-9864, June 2023.

According to one aspect, the Example may be carried out with one or more or a combination or mixture of the following materials which are indicated to useful for ERW or SAM or both and impact on pH or soil nutrients.

| | | | Other |
|---|---|---|---|
| Material | ERW | SAM | Comments |
| Lime/Limestone/Brucite/ | CO2 | Cooling | Good for soil |
| Portlandite | Consumption | Impact | pH |
| Wollastonite | CO2 | Cooling | Potentially |
| | Consumption | Impact | good for soil |
| | | | nutrients (P) |
| | | | and pH |
| Intermediate Rocks | CO2 | Cooling to | Potentially |
| (Andesite, Dacite etc.) | Consumption | warming | good for soil |
| | | impact, or | nutrients (P) |
| | | neutral | and pH |
| Quartz/Diatomaceous | None | Possible | Potentially |
| Earth | | Cooling | good for soil |
| | | Impact | nutrients (Si) |
| Basalt | CO2 | Neutral to | Potentially |
| | Consumption | Potential | good for soil |
| | | Warming | nutrients (P) |
| | | Impact | and pH |
| Olivine | CO2 | Neutral to | |
| | Consumption | Potential | |
| | | Warming | |
| | | Impact | |
| Ultramafic Rocks | CO2 | Neutral to | |
| (Serpentinites, | Consumption | Potential | |
| Dunite etc.) | | Warming | |
| | | Impact | |

### Example III

### Embodiments

Embodiments of the present disclosure are directed to a method of providing material to the surface of soil in land in a manner to increase soil albedo and provide enhanced rock weathering to remove CO₂, wherein the increased soil albedo results in greater reflectance of solar radiation and reduced radiative forcing compared to the soil without the material provided to the surface of the soil in the land. According to one aspect, the soil including the material also includes crop plants. According to one aspect, the land includes large tracts of land. According to one aspect, the material includes a calcium containing mineral. According to one aspect, the material includes wollastonite, calcite (calcium carbonate), magnesite (magnesium carbonate), brucite, calcium hydroxide, calcium oxide, or limestone or combinations or mixtures thereof. According to one aspect, the material is distributed on the surface of land in an amount covering at least 50% of the surface of the land. According to one aspect, the material is distributed on the surface of land and remains for a period of at least one growing season whereafter the material is tilled into the land. According to one aspect, the increased surface albedo is from 0.01 to 0.2. According to one aspect, the land includes an area of 0.1 hectare to 100,000 hectares. According to one aspect, the material is provided to the surface of the land in an amount of 1 to 100 tonnes per hectare.

1. A method comprising
providing material to the surface of soil in land in a manner to increase soil albedo and provide enhanced rock weathering to remove CO₂,
wherein the increased soil albedo results in greater reflectance of solar radiation and reduced radiative forcing compared to the soil without the material provided to the surface of the soil in the land.

2. The method of claim 1 wherein the soil including the material also includes crop plants.

3. The method of claim 1 wherein the land comprises large tracts of land.

4. The method of claim 1 wherein the material comprises a calcium containing mineral.

5. The method of claim 1 wherein the material comprises wollastonite, calcite (calcium carbonate), magnesite (magnesium carbonate), brucite, calcium hydroxide, calcium oxide, or limestone or combinations or mixtures thereof.

6. The method of claim 1 wherein the material is distributed on the surface of land in an amount covering at least 50% of the surface of the land.

7. The method of claim 1 wherein the material is distributed on the surface of land and remains for a period of at least one growing season whereafter the material is tilled into the land.

8. The method of claim 1 wherein the increased surface albedo is from 0.01 to 0.2.

9. The method of claim 1 wherein the land comprises an area of 0.1 hectare to 100,000 hectares.

10. The method of claim 1 wherein the material is provided to the surface of the land in an amount of 1 to 100 tonnes per hectare.
